(19) United States
(12) Patent Application Publication
(10) Pub. No.: US 2015/0066911 A1
(43) Pub. Date: Mar. 5, 2015

(54) APPARATUS AND METHOD FOR PROVIDING UNREGISTERED PHONE NUMBER AND INFORMATION ACQUIRED BY SEARCHING CALL LIST

(71) Applicant: Pantech Co., Ltd., Seoul (KR)

(72) Inventors: Hee Jong SEO, Seoul (KR); Byeong Hyeon Ko, Seoul (KR); Jeong Seok Lee, Seoul (KR)

(21) Appl. No.: 14/473,451

(22) Filed: Aug. 29, 2014

(30) Foreign Application Priority Data
Aug. 30, 2013 (KR) 10-2013-0104237

(51) Int. Cl. H04M 1/57; G06F 17/30; H04M 1/725

(52) U.S. Cl. CPC H04M 1/575; H04M 1/72583; G06F 17/30424
USPC 707/722; 707/771

(57) ABSTRACT

A method for extracting information associated with connection data in a mobile user terminal includes performing a search for connection data and obtaining connection data and associated information from a search result. Connection data includes any information in the search result that a user can employ to reach an intended target of the search such as a phone number, URI, e-mail address, etc. Associated information corresponding to the connection data is extracted from the search result to form extracted information. The extracted information is transmitted to a controller. The extracted information is reconfigured to a specified format to create formatted extracted information. The formatted extracted information is stored in a database.

### CROSS-REFERENCE TO RELATED APPLICATION

This application claims priority from and the benefit of Korean Patent Application No. 10-2013-0104237, filed on Aug. 30, 2013, which is hereby incorporated by reference for all purposes as if fully set forth herein.

### BACKGROUND

1. Field

Exemplary embodiments of the present invention relate to an apparatus and a method for processing contact/connection data searched through an application, and more particularly, to an information processing apparatus and method for providing, to a call list, contact/connection data searched through an application without storing the contact/connection data in a contact list of a terminal of a user.

2. Discussion of the Background

A phone number book, also referred to as a contact list, is stored in a terminal of a user. However, phone numbers of restaurants, credit card companies, department stores, and the like, that may be found through an Internet search may not be stored in the contact list due to an issue of personal information security.

Using a smartphone may facilitate a formation of an environment in which frequently used phone numbers may be acquired and immediately connected thereto by searching for the phone numbers, for example, by searching for the numbers from the Internet. However, management of the phone numbers may not suit a user requirement and thus, the phone numbers may need to be repeatedly searched as a need arises, resulting in an inconvenience to the user.

For example, when a phone number is not stored in the contact list, only the phone number may be displayed on a recent call list, also referred to as a call list, provided by the terminal of the user, without providing information associated with the phone number. Although the phone number is not stored in the call list, the user may need to dial the phone number not stored in the call list again, as a need arises. However, when the phone number is provided without information associated with the phone number (such as a company name), the user may need to search for the information associated with the phone number again through the Internet to discern the identity associated with the phone number.

However, when a phone number is registered in the contact list, there may be a risk of personal information being leaked through an application, for example, a social network service, that may be have access to the contact list.

### SUMMARY

A method for extracting information associated with connection data in a mobile user terminal includes performing a search for connection data and obtaining connection data and associated information from a search result. As used herein, the term “connection data” includes any information in the search result that a user can employ to reach an intended target of the search such as a phone number, URI, e-mail address, etc. Associated information corresponding to the connection data is extracted from the search result to form extracted information. The extracted information is transmitted to a controller. The extracted information is reconfigured to a specified format to create formatted extracted information. The formatted extracted information is stored in a database.

An information processing apparatus for a mobile user terminal includes an extractor for extracting information associated with connection data from an application search result. The connection data is selected from a phone number, a uniform resource locator, or an e-mail address. The extracted information is transmitted to a controller for reconfiguring a format of the extracted information to a storage format to create formatted extracted information. The controller is configured to transmit the formatted extracted information to an administrator. The administrator is configured to store the formatted extracted information in a database that associates the formatted extracted information with the connection data.

An information processing apparatus for a mobile user terminal includes a searcher for searching for connection data and associated information. An identifier identifies search term input used for searching for the connection data and associated information and stores the search term input used for searching for the connection data and the associated information. A classifier classifies the search term into multiple sets of field information when the search term includes multiple types of search term information. An administrator stores connection data and the associated information in a database.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration of an information processing apparatus according to an exemplary embodiment.

FIG. 2 is a diagram illustrating a display at each step of providing contact/connection data by an information processing apparatus according to an exemplary embodiment.

FIG. 3 is a diagram illustrating a process of providing detailed information about a phone number when the contact/connection number is selected from a call list according to an exemplary embodiment.

FIG. 4 is a flowchart illustrating an information processing method according to an exemplary embodiment.

FIG. 5 is a detailed flowchart illustrating an information processing method according to an exemplary embodiment.

FIG. 6 is a block diagram illustrating a detailed configuration of an extractor of an information processing apparatus according to an exemplary embodiment.

FIG. 7 is a detailed flowchart illustrating an operation of an extractor according to an exemplary embodiment.

FIG. 8 is a detailed flowchart illustrating an operation of a controller according to an exemplary embodiment.

FIG. 9 is a block diagram illustrating a configuration of an information processing apparatus according to another exemplary embodiment.

FIG. 10 is a block diagram illustrating a configuration of an information processing apparatus according to still another exemplary embodiment.

FIG. 11 is a diagram illustrating a process of providing a phone number and associated information in an information processing apparatus according to an exemplary embodiment.

FIG. 12 is a diagram illustrating a configuration of a table stored in a database (DB) of an information processing apparatus according to an exemplary embodiment.

### DETAILED DESCRIPTION OF THE ILLUSTRATIVE EMBODIMENTS

The invention is described more fully hereinafter with reference to the accompanying drawings, in which various embodiments are shown. This invention may, however, be embodied in many different forms and should not be construed as limited to the embodiments set forth herein. Rather, these embodiments are provided so that this disclosure is thorough, and will fully convey the scope of the concepts presented in the disclosure to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present.

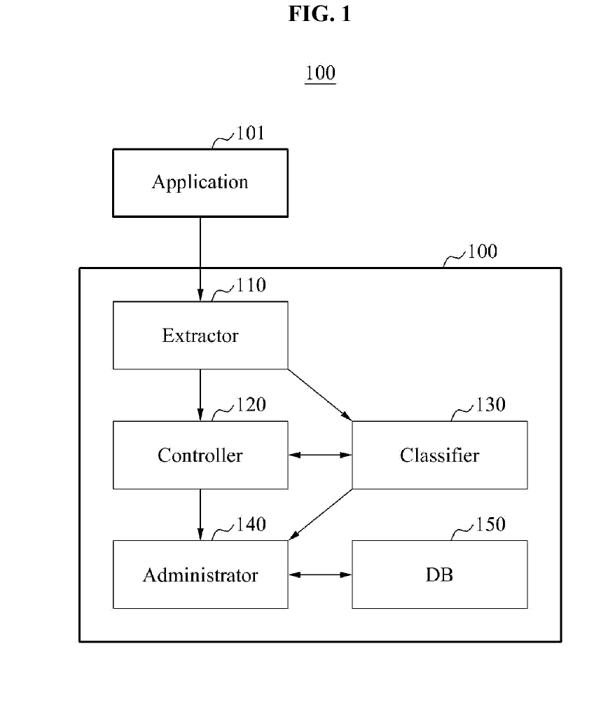

FIG. 1 is a block diagram illustrating a configuration of an information processing apparatus 100 according to an exemplary embodiment.

Referring to FIG. 1, the information processing apparatus 100 may include an extractor 110, a controller 120, a classifier 130, an administrator 140, and a database (DB) 150.

The information processing apparatus 100 may provide a phone number provided by an application 101 and information associated with the phone number. Although a user does not additionally store, or register, the phone number in the DB 150, for example, a contact list, the information processing apparatus 100 may provide the information associated with the phone number through a user interface such as a recent call list, also referred to as a call list. Thus, when contacting a target previously searched for at a later time, the user may not need to perform another search for the target.

When the user selects the call list of a terminal, the information processing apparatus 100 may display contact information associated with recent calls. The contact information may include contact numbers stored in the contact list, for example, a second DB, in which existing phone numbers possessed by the user are stored. When a contact number/connection data acquired through the application 101 providing a search function is displayed on the call list, although the contact number/connection data is not stored in the second DB, associated information may be output to a display of the terminal along with the telephone number.

The application 101 may provide a search function. Here, the user may search for a contact number/connection data of a target with whom the user desires to make contact using the application 101 providing the search function. As used herein, the expression “connection data” broadly includes any information in the search result that a user can employ to reach an intended target of the search including, but not limited to, a phone number, URI, e-mail address, etc. For example, the application 101 may be an Internet browser. Also, the application 101 may be a search tool or a third party application provided by a portal site.

The information associated with the phone number/connection data may be a result of the search. The search result may include at least one of a name, an address, an e-mail address, and an image.

The search result will be described as an example of information provided by the application 101, which is provided as an illustrative application for understanding and thus, may not be construed as being limited to an embodiment.

When the user selects a contact number/connection data from the search result after the user searches for the target, tag information including the associated information may be transmitted from the application 101 to the extractor 110.

The extractor 110 may extract the associated information corresponding to the contact number/connection data selected by the user. The extracting of the associated information may include receiving a tag including information about the contact number/connection data selected by the user, and extracting the associated information from the tag or by parsing the tag.

The contact number/connection data may include at least one of a phone number, a uniform resource locator (URL), and an e-mail address, in information included in the search result to be provided. The associated information may include at least one of name information, address information, location information, graphics information, and sound information corresponding to the contact number/connection data in the information included in the search result to be provided. The selecting of the contact number/connection data by the user may be performed to conduct at least one of initiating a call, sending a message, sending an e-mail, and visiting a linked page.

The extractor 110 may include a determiner, a first searcher, and a second searcher. The extractor 110 may extract the associated information corresponding to the contact number/connection data selected by the user from the search result provided through the application 101 providing the search function. The extractor 110 may transmit the extracted associated information to the controller 120.

The extractor 110 may verify whether the tag information transmitted from the application 101 is a name or an address, extract only information matching a pattern, and transmit the extracted information to the controller 120.

The controller 120 may verify the associated information transmitted from the extractor 110 and reconfigure a format of the information to match a format of the DB 150 prior to storing the information in the DB 150. The controller 120 may verify whether information about the contact number/connection data is included in the associated information and a format of the associated information satisfies a preset format, and reconfigure the format of the associated information to be storable in the DB 150.

The classifier 130 may classify the associated information into multiple sets of field information when the associated information includes multiple types of differing information.

The administrator 140 may store the contact number/connection data and the associated information about the contact number in the DB 150. The administrator 140 may store the associated information in DB 150 of the terminal by mapping the associated information to the contact number. The DB 150 may physically or logically differ from the contact list in which phone numbers possessed by the user of the terminal are stored. That is, the DB is distinct from the contact list of the mobile terminal.

When the associated information includes multiple types of differing information, the associated information may be classified into multiple sets of field information. When the contact number is mapped to the associated information, the administrator 140 may classify the associated information into the multiple sets of field information and store the classified information in the DB 150.

When the associated information includes multiple types of differing information, the associated information may be classified into multiple sets of field information and be output to the terminal. For example, the associated information may be classified into a phone number, an address, location information, and website information and displayed on the terminal.

The information processing apparatus 100 may recognize a phone number verbally provided during a call and display the phone number along with the call list. The information processing apparatus 100 may recognize a voice during the call, and expand a function to bring the contact list, or contact information associated with another phone number and an image, in addition to a function related to the phone number for calling. The information processing apparatus 100 may be used in all applications requiring a phone number. For example, the application 101 may use a call list, a message, and a mobile instant message (MIM) service.

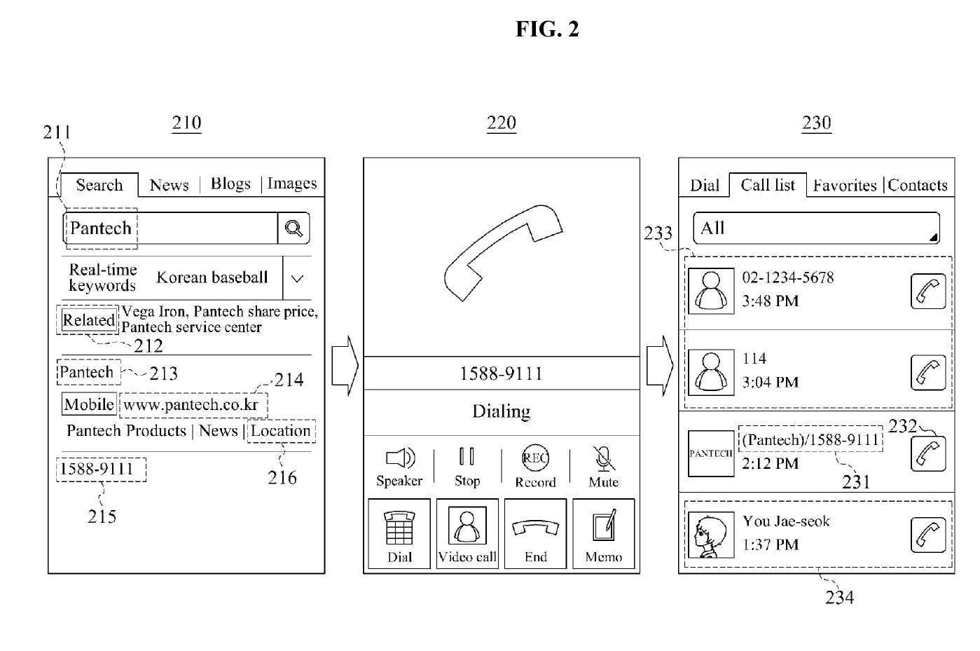

FIG. 2 is a diagram illustrating a display at each step of providing contact information by an information processing apparatus according to an exemplary embodiment of the present invention.

Step 210 may relate to a search 211 for a contact number of a target using a terminal by a user. The user may search for the target using an application providing a search function. For example, the application providing the search function may be portals such as Never®, Daum®, Google®, Nate®, and the like used on a frequent basis.

For example, the user may search for a phone number, or a contact number/connection data, to contact a department store, a company, a restaurant, a gym, and the like, that is not stored in a phone number list of the terminal, using the application providing the search function. Information included in a search result may include at least one of name information 213, website information 214, a phone number 215, location information 216, graphics information, and sound information.

For example, the user may search for a company named “Pantech” using a Naver® application installed on the terminal. When the user inputs Pantech as a search word and searches for the company, information about Pantech may be displayed on a display of the terminal. The information about Pantech may include currently released products, stock prices, and service centers, which are provided as a related search keyword 212. Also, the phone number 215 of Pantech may be displayed on the display of the terminal. In addition to the phone number 215, a URL, the location information 216, and product information may be displayed.

In step 220, the user may perform a specific action using contact information obtained from the search result. The action performed using the contact information may include at least one of dialing, sending an e-mail, and visiting a linked page using the URL.

For example, the user may dial the phone number 215 by selecting the phone number 215 from the search result obtained by searching for information related to Pantech by inputting Pantech as the search word 211. Also, the user may send an e-mail and visit a website by selecting the URL, www.pantech.co.kr.

In step 230, the associated information, or the contact information 231 for the search word 211 input by the user in the call list of the terminal may be displayed along with the contact number or the phone number. When a contact number is not stored in a phone number list, a terminal used on a daily basis may not display associated information along with the contact number, but display only the contact number on a call list. In step 230, the associated information 231 about the contact number may be displayed on the call list, although the contact number is not stored in the terminal. That is, the associated information 231 about the phone number, for example, the name, may be briefly provided to the call list in a user interface manner without separately storing the associated information 231 in the phone number list. Thus, the user may contact the phone number again as a need arises only by looking at the call list.

For example, when a phone number not stored in the phone number list of the user is received by the terminal, only a phone number of a caller may be displayed without associated information on the caller as seen in 233.

For another example, when the user selects the call list in the terminal, a list of recent calls may be displayed. When the user makes an outgoing call to Pantech, information about Pantech may be displayed next to the phone number in the call list. Here, to differentiate a method of displaying the contact number/connection data, Pantech may be displayed using parentheses, for example, “(Pantech).” When the user needs to call Pantech again, the user may call Pantech directly by selecting a call button 232 without searching for Pantech again through the Naver® application.

In still another example, when a phone number stored in the phone number list of the user is received by the terminal, information about a caller, for example, a stored name, may be displayed. The information about the caller may be displayed in addition to the phone number of the caller.

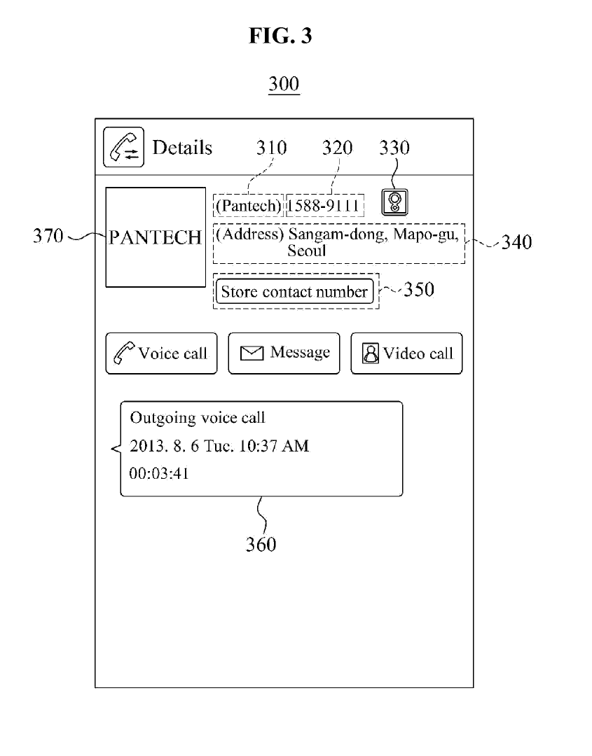

FIG. 3 is a diagram illustrating a process 300 of providing detailed information associated with a contact number when the contact number is selected from a call list according to an exemplary embodiment of the present invention.

Referring to FIG. 3, when the contact number/connection data obtained through the application 101 providing a search function is displayed on the call list of a terminal, associated information including, for example, parentheses 310, a phone number 320, location information 330, address information 340, and call time information 360, may be output to a display of the terminal along with the contact number. The contact number may be provided by being included in a search result and include at least one of the phone number 320, a URL, an e-mail, and an address.

Also, the associated information may include at least one of name information 310, address information 340, location information 330, graphics information 370, and sound information corresponding to the contact number/connection data provided through inclusion in the search result.

When multiple types of differing information are included in the associated information, the associated information may be classified into multiple sets of field information and output to the terminal.

For example, when the user selects an item Pantech from the call list, the detailed information may be displayed. In the detailed information, the associated information about Pantech may be displayed. The associated information may include the phone number 320, the address information 340, the location information 330, and website information. On the display, a phrase “The information is temporally stored” may be displayed because the contact number is not stored in a phone number list of the user.

Also, Pantech may be input in the parentheses 310 to indicate that the phone number is a search result not stored in the phone number list/contact list of the mobile terminal. The contact number may be differentiated from a contact number stored in the phone number list/contact list of the user by indicating the telephone number using the parentheses 310. The user may select “store contact number” 350 and store the contact number in the phone number list. The user may select at least one of “voice call,” “send message “and” video call” from the detailed information, and immediately contact Pantech. In the detailed information, the information 360 about a time at which the call is made and calling time may be displayed.

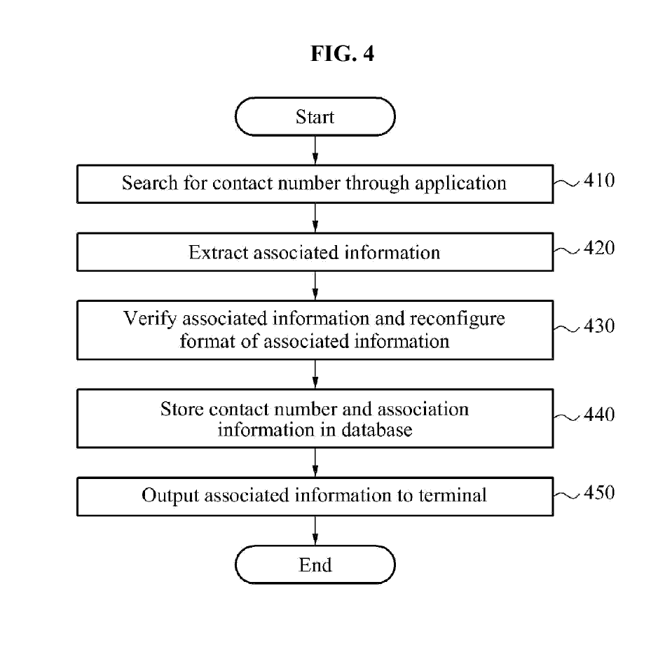

FIG. 4 is a flowchart illustrating an information processing method according to an exemplary embodiment of the present invention.

In operation 410, a user may search for a contact number/connection data of a target with which the user desires to make contact through an application 101 providing a search function. The user may search for the contact telephone number. When the user finds the target with which the user desires to make contact and selects the contact number from a search result, tag information including associated information may be transmitted to the extractor 110.

In operation 420, the associated information corresponding to the contact number/connection data selected by the user may be extracted. The contact number may include at least one of a phone number, a URL, and an e-mail address in information included in the search result. The associated information may include at least one of name information, address information, location information, graphics information, and sound information, corresponding to the contact number in the information included in the search result. The selecting of the contact number/connection data by the user may be performed to conduct at least one of initiating a call, sending a message, sending an e-mail, and visiting a linked page.

The operation of extracting the associated information may include receiving a tag including information about the contact number/connection data selected by the user and extracting the associated information by parsing the tag or from the tag.

The extractor 110 may extract only information matching a pattern by verifying whether the tag information transmitted from the application 101 relates to a name or an address, and transmitted the extracted information to the controller 120.

In operation 430, the controller 120 may verify the associated information transmitted from the extractor 110, and reconfigure a format of the information to match a format of the DB 150 prior to storing the associated information in the DB 150.

The controller 120 may verify whether the associated information includes information about the contact number/connection data and whether the format of the associated information satisfies a preset format, and reconfigure the format of the associated information to be storable in the DB 150.

In operation 440, the administrator 140 may store the contact number/connection data and the associated information about the contact number/connection data in the DB 150. The DB 150 may physically or logically differ from the contact list in which phone numbers are stored in the terminal. That is, the database is distinct from a contact list of a mobile terminal.

When the associated information includes multiple types of differing information, the associated information may be classified into multiple sets of field information. When the contact number/connection data is mapped to the associated information, the administrator 140 may classify the associated information into the multiple sets of field information and store the classified associated information in the DB 150.

In operation 450, when the contact number/connection data for which the user searches in the terminal is displayed, the associated information may be output along with the contact number/connection data.

When the contact number obtained through the application 101 providing the search function is displayed on the call list of the terminal, the associated information may be output to the display of the terminal along with the contact number/connection data. When the associated information includes multiple types of differing information, the associated information may be classified into multiple sets of field information and output to the terminal. For example, the associated information may be classified into a phone number, an address, location information, and website information, and the classified associated information may be output to the terminal.

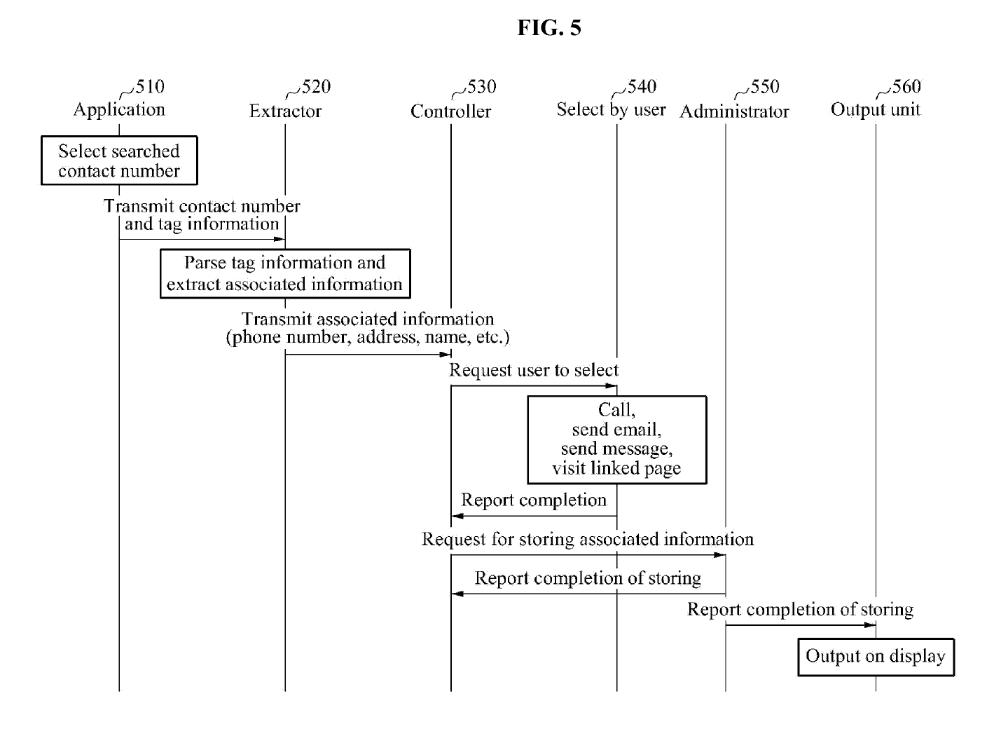

FIG. 5 is a detailed flowchart illustrating an information processing method according to an exemplary embodiment of the present invention. Please refer to FIG. 1 for the information processing elements of FIG. 5.

In operation 510, a user may search for a contact number of a target using the application 101. A search result may include a single set or multiple sets of contact information/connection data. When the user selects a contact phone number, the application 101 may transmit tag information including associated information about the contact phone number to the extractor 110. Here, the application 101 may provide a search function. The associated information may include at least one of name information, address information, location information, graphics information, and sound information, corresponding to the contact number, for example, a first contact number, in information included in the search result.

In operation 520, the extractor 110 may extract the associated information corresponding to the contact number/connection data from the search result provided through the application 101. The contact number may be selected by the user. The application 101 may provide the search function. The search result may include the tag information including the associated information.

The extractor 110 may extract the associated information by parsing the tag information transmitted from the application 101 or extract the associated information from the tag information. The extractor 110 may extract only information matching a pattern by verifying text information in the tag related to a name or an address using the pattern for information classification. The extractor 110 may transmit the extracted information to the controller 120.

In operation 530, the controller 120 may verify the associated information transmitted from the extractor 110 and reconfigure a format of the associated information to match a format of the DB 150.

The controller 120 may verify whether the associated information transmitted from the extractor 110 is correct, and change the format of the associated information to match the format of the DB 150 prior to storing the associated information in the DB 150. The controller 120 may configure the associated information to be in a form of a transmittable parameter and temporally store data in the DB 150. When the user selects one option, for example, calling, sending an e-mail, sending a message, and visiting a linked URL, the controller 120 may transmit the temporally stored data to the DB 150.

In operation 540, the user may select one option. The user may select at least one of initiating a call, sending a message, sending an e-mail, and visiting a linked page, with respect to the contact number/connection data of the target with which the user desires to make contact.

When the user selects one option, the controller 120 may be informed that an option selection process is completed by the user. The controller 120 may request the administrator 140 to store, in the DB 150, the data reconfigured to match the format of the DB 150.

In operation 550, the administrator 140 may store the associated information about the contact number/connection data in the DB 150 of the terminal by mapping the associated information to the contact number/connection data. The DB 150, also referred to as a first DB, in which the associated information is to be stored may physically or logically differ from a contact list, also referred to as a second DB, in which phone numbers possessed by the user are registered. That is, the database is distinct from a contact list of a mobile terminal. When a contact number/connection data for which the user searches is displayed on the terminal, an output unit may output the associated information along with the contact number/connection data.

When the associated information includes multiple types of differing information, the associated information may be classified into multiple sets of field information. Here, when the contact number/connection data is mapped to the associated information, the associated information may be stored by being classified into the multiple sets of field information. The output unit may output the classified information to the terminal.

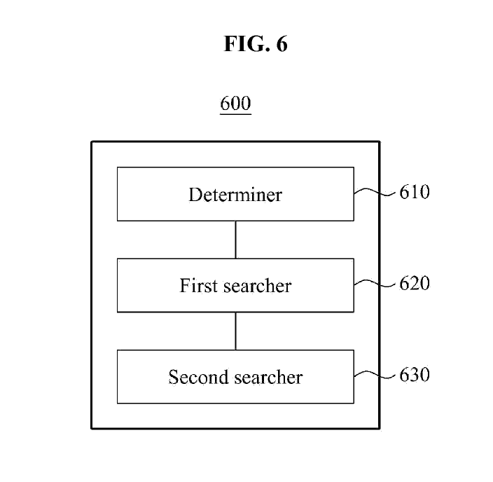

FIG. 6 is a block diagram illustrating a detailed configuration of an extractor 600 of an information processing apparatus according to an exemplary embodiment of the present invention.

Referring to FIG. 6, the extractor 600 may include a determiner 610, a first searcher 620, and a second searcher 630. The extractor 600 may extract associated information about a contact number/connection data selected by a user from a search result to be provided through the application 101 providing a search function. The extractor 600 may transmit the extracted associated information to the controller 120.

The determiner 610 may receive a tag including the associated information about the contact number from the application 101. The determiner 610 may determine a search word input by the user. The search word input by the user may be determined through tag search.

The determiner 610 may determine the search word input by the user through an input tag. The input tag may be a tag used to receive an input in hypertext markup language (HTML) format, and an object to receive a value corresponding to an action or a request by the user. The input tag may be required to receive an input of a search word in a browser. Thus, the search word input by the user may be determined based on an input value.

For example, when the user inputs a search word “cafe,” an input tag may be configured as follows, and a type of the search word input by the user may be determined to be, for example, text, and a value, or the search word, may be determined based on the following.

<input type=“text” title=“search” name=“query” id=“nx_query_btm”

maxlength=255 class=“box_window” autocomplete=“off”
value=“cafe”>

Multiple input tags may be present to configure a browser display. To determine a correct value input by the user, the following conditions may need to be satisfied. The input type may not be “hidden.” The hidden attribute may be a hidden field that is hidden from a display. A user input field may be a visible search word field and thus, the hidden attribute may need to be excluded. The value may not be “empty.” The value may be a portion to which the value input by the user is inserted. Thus, the empty attribute may need to be inapplicable.

An example in which the conditions are not satisfied is as follows.

<input type=“hidden” value=” “name=“qdt” disabled>

The first searcher 620 may find a tag matching a phone number to be transmitted when the display changes based on an option selected by the user from among calling, sending a message, visiting a linked page, and sending an e-mail.

A location of the tag related to the phone number may be used to find a value matching a phone number the user desires to dial or a phone number having a hypertext reference (href) attribute of an “A” tag in an upper tag. For example, the phone number having the href attribute among attributes of the a tag may be found to make a call in a form of “tel:xxx-xxxx.”

<a href=“tel:02xxxxxxx” class=“btm” onclick=“goOtherTCR(this, ‘a =
loc_plt.call&r = 1&i=12947573’);”>
<span class=“ic_tel”>02-xxx-xxxx</span></a>

The second searcher 630 may find whether an adjacent tag, for example, an upper or a sibling tag, of the tag found by the first searcher 620 includes a value corresponding to an address pattern, or a name.

For example, an address may be found using a character pattern list, for example, a character string of Seoul, Gyeonggi, Mapo-gu, including address information based on a regular expression. Here, the regular expression may refer to an expression to form a pattern of a character. In a case of a character string that does not match the address pattern, the second searcher 630 may determine whether the character string is matched using an initially determined search word as a pattern character. When the character string is matched, the matched pattern character may be used as the name.

<div class=“info_addr”>
<em class=“screen_out”>address</em>
<span class=“f_db”>
XXX-XX, Sangam-dong, Mapo-gu, Seoul
</span>
</div>
<div class=“wrap_btn”>
<a href=“tel:02-XXX-XXXX”. ...>
<span class=“inner”>02-XXX-XXXX </span>
</a>
..........
</div>

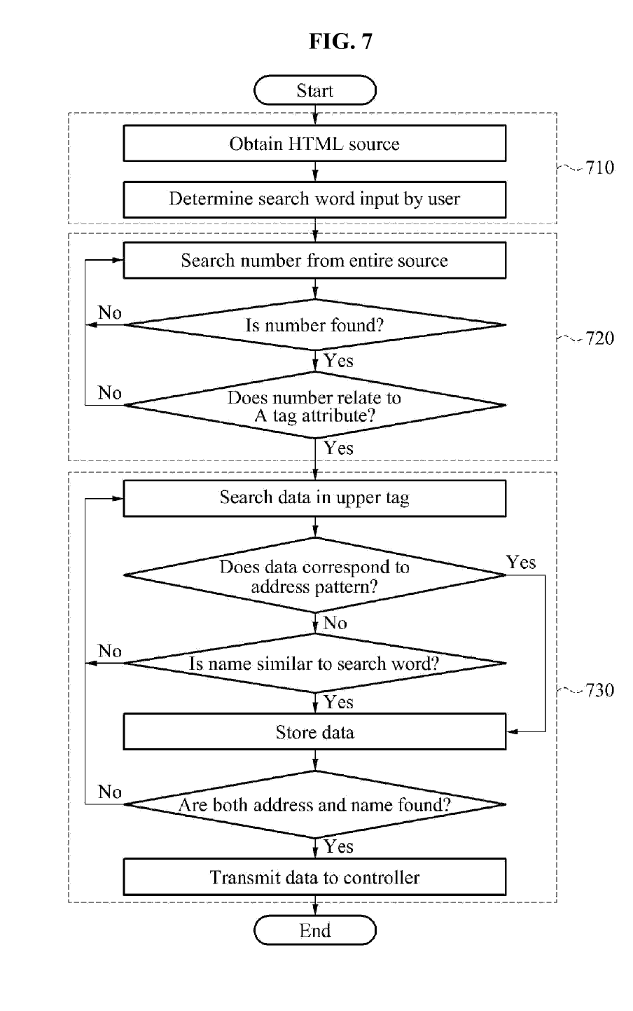

FIG. 7 is a detailed flowchart illustrating an operation of the extractor 600 according to an exemplary embodiment of the present invention. Please refer to FIG. 6 for the configuration of the extractor.

In operation 710, the determiner 610 may receive a tag including associated information about a contact number from an application, and determine a search word input by a user based on the tag.

In operation 720, when a display changes based on an option selected by the user from among calling, sending a message, visiting a linked page, and sending an e-mail, the first searcher 620 may search for a number related to the contact number from an entire source, for example, tag information received from the application. After the first searcher 620 finds the number related to the contact number, for example, a phone number, the first searcher 620 may verify whether the number relates to an attribute of an A tag. When the number does not relate to the attribute of the A tag, the first searcher 620 may search for the number again from the entire source.

Here, the A tag may refer to an “anchor.” The anchor may indicate a connection. The A tag may have a mandatory attribute indicated as “href,” which may indicate “refer to a resource.” The A tag may indicate the connection meaning “refer to another resource.” For example, the user may search for “Pantech” and select a phone number from a page on which a search result is displayed. When the display changes to a display for calling based on an option selected by the user, information, for example, “tel:1588-9111,” about the contact number having the href may be found from an HTML source.

In operation 730, the second searcher 630 may search data in an adjacent tag, for example, an upper or a sibling tag of a tag found by the first searcher 620. When an address pattern is found in the data, address pattern data may be stored. When the address pattern is not found in the data, a name similar to the search word may be found and stored as name data. When an address and a name are not found, the extractor 600 may match the search word input by the user with the contact number, for example, the phone number, and store the search word input by the user as search word data. When the address and the name are found, the extractor 600 may transmit the data including the address pattern data, the name data, and the search word data to the controller 120.

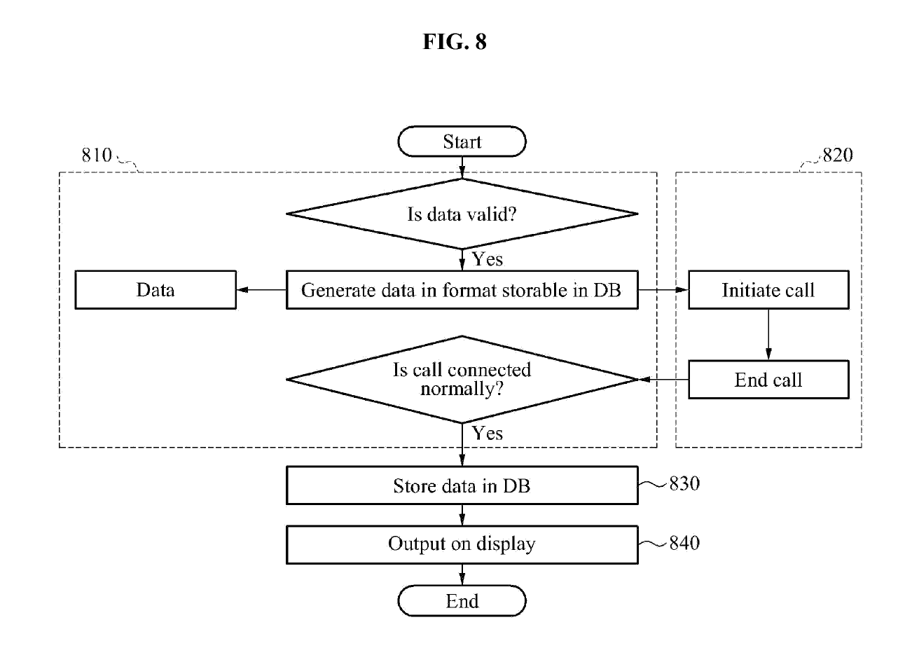

FIG. 8 is a detailed flowchart illustrating an operation of the controller 120 according to an exemplary embodiment of the present invention. Please see FIG. 1 and its accompanying description for the relationship among the controller 120, administrator 140, and database 150.

In operation 810, the controller 120 may verify whether associated information transmitted from the extractor 110 includes a phone number, an address, and a name. When the associated information includes the phone number, the address, and the name, the controller 120 may verify whether a format of the associated information is correct. The controller 120 may reconfigure the format of the associated information to be storable in the DB 150 prior to storing the associated information in the DB 150 and temporally store the associated information in the DB 150. The controller 120 may request a user to select an option from, for example, calling, sending an e-mail, sending a message, and visiting a linked URL, and allow the associated information to be stored in the DB 150 when the user completes selecting the option normally.

In operation 820, the user may select an option. The user may select the option from, for example, calling, sending an e-mail, sending a message, and visiting a linked URL, with respect to a target searched for through an application and to which the user desires to connect. For example, the user may make a call by selecting a phone number from information obtained from a search result.

In operation 830, the administrator 140 may store the associated information in the DB 150. The DB 150, also referred to as a first DB, may physically or logically differ from a contact list, also referred to as a second DB, in which individual phone numbers are stored. That is, the first database DB is distinct from a contact list of a mobile terminal. The associated information may include at least one of name information, address information, location information, graphics information, and sound information, corresponding to the contact number/connection data among sets of information provided in the search result.

When the associated information includes multiple types of differing information, the associated information may be classified into multiple sets of field information. The administrator 140 may store the classified associated information when the contact number is mapped to the associated information.

In operation 840, when the contact number is displayed on a terminal of the user, the associated information may be output along with the contact number.

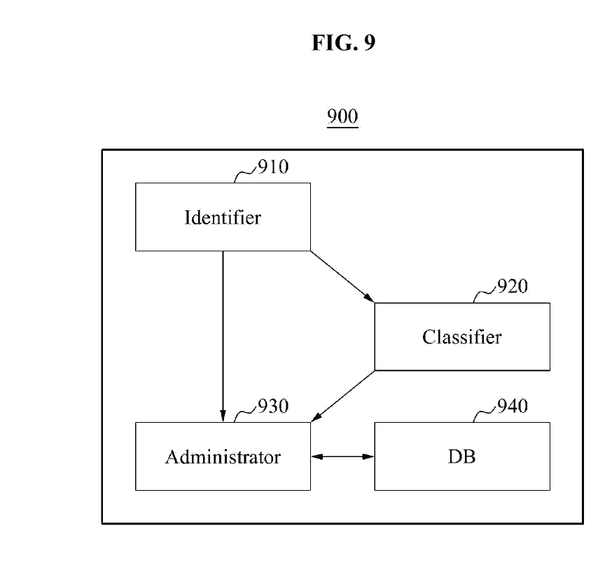

FIG. 9 is a block diagram illustrating a configuration of an information processing apparatus 900 that may display, on a call list, a phone number and contact information obtained through search without storing the phone number and the contact information according to another exemplary embodiment of the present invention.

The information processing apparatus 900 may include an identifier 910, a classifier 920, an administrator 930, and a DB 940. In the information processing apparatus 900, a user may search for a target of a contact number using an application providing a search function. The information processing apparatus 900 may omit an operation of extracting associated information, for example, a phone number, an address, and a name, from a search result, and immediately store the associated information in the DB 940 by mapping a search word input by the user to the contact number selected by the user from the search result.

The identifier 910 may identify the search word input with respect to the target by the user to the application providing the search function. The identifier 910 may store the target input by the user to the application through an input method editor (IME). The identifier 910 may identify the target input through the IME as the search word.

For example, when the user inputs “Vega Iron” as a search word, the identifier 910 may identify the Vega Iron as the search word.

The classifier 920 may classify the search word into multiple sets of field information when the search word includes multiple types of differing information.

For example, when a natural phrasing search term is input, for example, “Which subway line do I take to Pantech,” “Can I find Pantech in Sangam-dong?,” and “Pantech Vega Iron,” the classifier 920 may parse the search term and classify the search term into fields, for example, a name field corresponding to Pantech, a URL information filed, a traffic information field including subway or bus lines, and a product information field about Vega Iron.

The administrator 930 may store, in the DB 940, the contact number selected from the search result in response to the search term by mapping the contact number to the search term. When the user makes a call by selecting a phone number from the search result, the administrator 930 may store the phone number and the search term in the DB 940 by matching the phone number to a search word from the input search term. The DB 940, also referred to as a first DB, may physically or logically differ from a contact list, also referred to as a second DB, in which individual phone numbers are stored. That is, the first database DB is distinct from a contact list (second DB) of a mobile terminal. The contact number/connection data may include at least one of a phone number, a URL, an e-mail address, from information provided in the search result. That is, the expression “contact number/connection data” includes any information in the search result that a user can employ to reach an intended target of the search. The search term may include multiple types of differing information. The administrator 930 may classify the search term into multiple sets of field information, and store a set of field information among the multiple sets of field information along with the contact number in the DB 940.

For example, when “Vega Iron” is identified as a search term, the search result may include “Pantech” as the manufacturer of the Vega Iron, agents selling the Vega Iron, service centers providing a service related to the Vega Iron, and the like. The information processing apparatus 900 may omit an operation of extracting the associated information, for example, a name and an address, with respect to the Vega Iron from the search result, and immediately map the contact number selected by the user to the search term and store the contact number in the DB 940. For example, when the user selects a contact number of an agent via which the Vega Iron may be purchased, the information processing apparatus 900 may map the contact number of the agent selected by the user among the search result provided with respect to the search term, Vega Iron, and store the contact number of the agent in the DB 940.

For another example, when a natural phrasing search term is input, for example, “Which subway line do I take to Pantech,” “Can I find Pantech in Sangam-dong?,” and “Pantech Vega Iron,” the classifier 920 may parse the search term and classify the search term into fields, for example, a name field corresponding to Pantech, a URL information field, a traffic information field including subway or bus lines, and a product information field about the Vega Iron. The administrator 930 may store the multiple sets of field information in the DB 940.

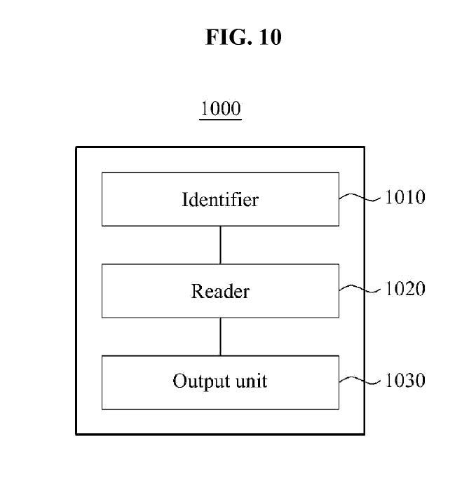

FIG. 10 is a block diagram illustrating a configuration of an information processing apparatus 1000 according to still another exemplary embodiment of the present invention.

The information processing apparatus 1000 may include an identifier 1010, a reader 1020, and an output unit 1030. To display a contact number/connection data which is not stored in a contact list, for example, a second DB, in which individual phone numbers are stored, the information processing apparatus 1000 may read associated information about the contact number/connection data that a user desires to find from a DB, for example, a first DB, different from the second DB and display the associated information on a terminal.

When the contact list is called, the identifier 1010 may identify the contact number not stored in the second DB in which the individual phone numbers are stored from among contact numbers.

For example, when the user selects a call list of the terminal, the user may check recent call records. In the call list, phone numbers included in the second DB in which the individual phone numbers are stored or phone numbers, for example, 1588-XXXX, that are not included in the second DB may be present. The terminal may identify the contact number/connection data by comparing the phone numbers, for example, 1588-XXXX, and a phone number of, for example, Pantech, stored in the first DB.

The reader 1020 may read the associated information about the contact number/connection data from the first DB different to the second DB.

In an example, the associated information may be identified to correspond to the contact number from a search result to be provided through an application providing a search function and stored in the first DB.

In another example, the associated information may be at least a portion of a search term input to search for the contact number/connection data through the application providing the search function. For example, when the user inputs a search term of “Pantech Vega Iron” to buy the product, the search result may include Pantech, agencies selling the Vega Iron, and service centers providing service for the Vega Iron. The user may select Pantech to obtain product information about the Vega Iron and call a Pantech customer service center by selecting Pantech. The reader 1020 may read at least a portion, for example, Pantech, of the search term, Pantech Vega Iron, from the first DB.

The output unit 1030 may include the associated information in the contact list along with the contact number/connection data and output the associated information on the terminal.

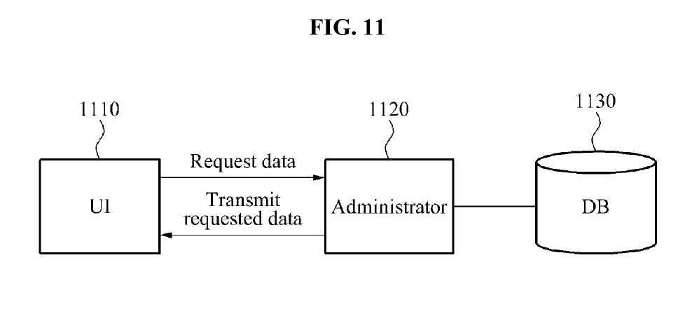

FIG. 11 is a diagram illustrating a process of providing a phone number and contact information/associated information in an information processing apparatus according to an exemplary embodiment of the present invention.

In an event that a phone number is not found in a call list when a user interface (UI) display 1110 displays, call records and message records associated with the phone number, the information processing apparatus may transmit the phone number to a DB 1130 as a key value and request name and address information associated with the phone number. When the information associated with the received phone number is in the DB 1130, the UI display 1110 may be informed of the name and the address by the DB 1130. The UI display 1110 may then display the received name and the address.

When the phone number is not present in the call list, the UI display 1110 may request the name and the address information associated with the phone number through an administrator 1120. The UI display 1110 may transmit the phone number as the key value to the administrator 1120.

The administrator 1120 may verify whether the information associated with the phone number is present in the DB 1130 based on the received key value. When the information is present in the DB 1130, the administrator 1120 may transmit the information, for example, the name and/or the address, to the UI display 1110.

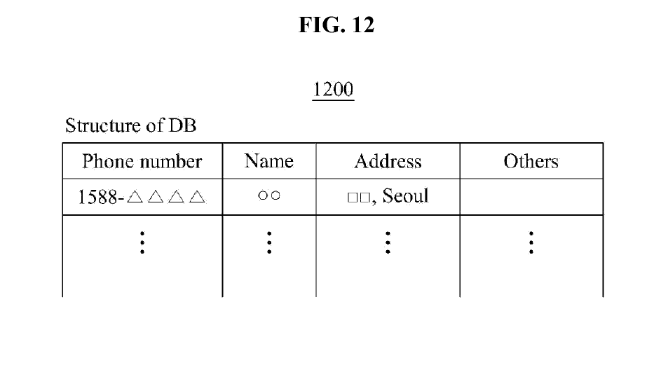

FIG. 12 is a diagram illustrating a configuration of a table stored in a DB 1200 of an information processing apparatus according to an exemplary embodiment of the present invention.

The administrator 140 may store associated information in the DB 1200, also referred to as a first DB as an example of DB 150 of FIG. 1. The table stored in the DB 1200 may include at least one of name information, address information, location information, graphics information, and sound information, corresponding to a contact number/connection data. The DB 1200 may physically or logically differ from a contact list, also referred to as a second DB, in which individual phone numbers are stored. That is, the first database DB is distinct from a contact list (second DB) of a mobile terminal.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for extracting information associated with connection data in a mobile user terminal comprising:
performing a search for connection data;
obtaining connection data and associated information from a search result;
extracting the associated information corresponding to the connection data from the search result to form extracted information;
transmitting the extracted information to a controller;
reconfiguring the extracted information to a specified format to create formatted extracted information; and
storing the formatted extracted information in a database.

2. A method for extracting information associated with connection data in a mobile user terminal according to claim 1, wherein the database is distinct from a contact list storing contact phone numbers in the mobile user terminal.

3. A method for extracting information associated with connection data in a mobile user terminal according to claim 1, further comprising using a tag to extract the associated information.

4. A method for extracting information associated with connection data in a mobile user terminal according to claim 1, wherein the connection data comprises a phone number, a uniform resource locator, or an e-mail address.

5. A method for extracting information associated with connection data in a mobile user terminal according to claim 1, wherein the associated information is selected from name information, address information, location information, graphics information, and sound information.

6. A method for extracting information associated with connection data in a mobile user terminal according to claim 1, further comprising transmitting the formatted extracted information to an administrator for storing the formatted extracted information in the database.

7. A method for extracting information associated with connection data in a mobile user terminal according to claim 1, further comprising classifying the extracted information into multiple sets of field information when the extracted information includes multiple types of extracted information.

8. An information processing apparatus for a mobile user terminal comprising:
an extractor configured for extracting information associated with connection data from an application search result, the connection data selected from a phone number, a uniform resource locator, or an e-mail address;
a controller configured to received extracted information from the extractor, the controller being further configured for reconfiguring a format of the extracted information to a storage format to create formatted extracted information; and
an administrator being configured to receive formatted extracted information from the controller and being further configured to store the formatted extracted information in a database that associates the formatted extracted information with the connection data.

9. An information processing apparatus for a mobile user terminal according to claim 8, wherein the database is distinct from a contact list storing contact phone numbers in the mobile user terminal.

10. An information processing apparatus for a mobile user terminal according to claim 8, further comprising a classifier to classify the extracted information into multiple sets of field information when the extracted information includes multiple types of extracted information.

11. An information processing apparatus for a mobile user terminal according to claim 8, wherein the administrator is further configured to map the extracted information to the connection data.

12. An information processing apparatus for a mobile user terminal according to claim 8, wherein the extractor is further configured to receive a tag for extracting information associated with the connection data based on the tag.

13. An information processing apparatus for a mobile user terminal according to claim 8, wherein the extracted information is selected from name information, address information, location information, graphics information, and sound information.

14. An information processing apparatus for a mobile user terminal according to claim 8, wherein the extractor further includes a determiner and at least one searcher.

15. An information processing apparatus for a mobile user terminal comprising:
a searcher for searching for connection data and associated information;
an identifier for identifying a search term input used for searching for the connection data and associated information and for storing the search term input used for searching for the connection data and the associated information;
a classifier for classifying the search term into multiple sets of field information when the search term includes multiple types of search term information; and
an administrator for storing the connection data and the associated information in a database.

16. An information processing apparatus for a mobile user terminal according to claim 15, wherein the database is distinct from a contact list storing contact phone numbers in the mobile user terminal.

17. An information processing apparatus for a mobile user terminal according to claim 15, wherein the connection data is selected from a phone number, a uniform resource locator, or an e-mail address.

18. An information processing apparatus for a mobile user terminal according to claim 15, wherein the connection data is mapped to the associated data by the search term input used for searching for the connection data and associated information.

19. An information processing apparatus for a mobile user terminal according to claim 15, further comprising:
an identifier for identifying the connection data from the database;
a reader for reading the associated information from the database; and
an output unit for outputting the associated information from the database.

20. An information processing apparatus for a mobile user terminal according to claim 19, further comprising a user interface display for displaying the connection data and the associated information from the database.
